(19) United States
(12) Patent Application Publication
(10) Pub. No.: US 2013/0057189 A1
(43) Pub. Date: Mar. 7, 2013

(54) REVOLUTION STABILIZATION CONTROL (RSC) SYSTEM

(71) Applicant: John Frank MIDDLEMISS, Shelby, MT (US)

(72) Inventor: John Frank MIDDLEMISS, Shelby, MT (US)

(21) Appl. No.: 13/591,315

(22) Filed: Aug. 22, 2012

Related U.S. Application Data
(60) Provisional application No. 61/575,630, filed on Aug. 25, 2011.

(51) Int. Cl. H02P 5/00

(52) U.S. Cl. 318/461

(57) ABSTRACT

The present invention converts conventional electric motors into dual rotational machines. The extreme novelty and utility of such an apparatus rests with the fact that it offers a revolutionary method of precision RPM control to accessory systems that could become far more effective and efficient if run at speeds independent of the RPM produced by the primary drive source said accessory systems are coupled to. Conversion of conventional motors consists of precision modification and balancing of a motors case/stator sufficient to maintain a steady state RPM consistent with the needs of dependant accessory systems. Superimposing a method of coupling accessory systems to the drive speeds of the present inventions case/stator suggests many options—e.g. drive belt pulley. Attachment to a primary drive source could be a simple bore through the rotor assembly.

### CROSS-REFERENCE TO RELATED APPLICATION

This non-provisional patent application is consistent with, and related to U.S. Provisional Patent Application No. 61/575,630 filed on Aug. 25, 2011. The disclosure made therein is hereby incorporated in it's entirety, and expanded upon for purposes of this non-provisional patent application.

### FIELD OF INVENTION

The present invention is specific to the field and art of electric motors, and their requisite electronic control systems designs, with emphasis on the fact that as complex as electric motors, and electronic motor control systems have become, the present invention takes those effective, proven and complex technologies to extreme new levels of application and performance not yet considered or explored by related industries. The present invention takes existing motor, and motor control technologies to extreme new levels of usefulness not yet considered or explored as will be exemplified infra.

### BACKGROUND OF THE INVENTION

Electric motors are widely used and effect every aspect of modern life whether at home, in the office, of at work—and in fact have been evolving at a steady pace over the past several decades, noting that the related advent of advancements in electronics, personal computers, and soft-ware technologies do in fact create a significant impact upon the effectiveness and ease of adaptability of the present invention.

Electric motor and motor control designers and engineers concerns are ever present in the quest for improved performance, greater diversity in application, and efficiency of operation. It is in that spirit that the present invention was inspired—and without a doubt, the present invention offers extreme potential for the elements of the above referenced quest.

Clearly motor drive electronics have experienced extreme advancements in packaging, control parameters, and power as well as in interconnectivity and communication capabilities that have allowed motors to reach the cutting edges of effectiveness and efficiency they have—and in fact adapt to new applications with very little down time whether in homes, offices, or at work. It is precisely the cutting edge advancements of electric motors, motor control electronics, and magnetic material technologies that lands ease and certainty to the development and application of the present invention as embodied in our RSC System. It is the assertion of this inventor that the present invention compliments the current state of art in reference to electric motors, and motor controls, and in fact through novelty and improvement proposes only to take existing technologies to extreme new levels of performance and application.

The timing of the present invention could not be more ideal with the ever growing public and consumer concerns and demands for solutions to counter ever increasing energy costs, solutions to counter unnecessary energy consumption and waste, and solution to counter the subsequent negative environmental impact—all of which has caused legislatures and the self interests of industry to push nard for innovation and invention that improves motor efficiency and performance.

It is estimated that more than 50% of the electricity generated in the U.S. alone is consumed by electric motors, with more than 10% wasted on motors that run in some form of idle mode—and that is to say nothing of other significant inefficiency problems such as the one addressed by the present invention.

With a world wide manufacturing rate of over 15 million electric motors per day it is the assertion of this inventor that no other electric motor offers the novel and extremely useful feature of functioning as a dual rotational device or machine—a feature that represents the potential for extreme new levels of performance and application for which in turn offers great potential in reference to the quest for improved energy efficiency, reduced, energy costs, and concerns for the environmental impacts of energy consumption.

Microcontrollers (MCU's), sensors, and digital signal processors are routinely and extensively used for precision motor controls, and are being routinely designed for countless job specific applications. A motor control specific MCU typically measures the speed and position of a motors rotor, and calculates the resulting torque, accepts feed back input, and calculates the timing and amplitude of the current pulses that energize the windings. Even MCU's for three phase brushless DC motor controls such as Motorola's MC68HC705MC4 for example contains the necessary elements to include six PWM output lines and timer inputs for hall sensors—and that technology in motor control electronics while effective and compatible with the present invention—is now generations behind current industry advancements and standards—a fact which further authenticates the potential and ease of putting the present invention into job specific operations through the incorporation of MCU's, sophisticated digital sensors/controls, and reduced instruction set computers (RISC's). Current industry standards where motor controls are concerned use complex systems that involve the simultaneous calculation and contra of several variables with precision results. Even the innovation of sensorless vector control technology can be adapted to accommodate the job specific design parameters of the present invention.

Direct torque control is yet another technology that could in fact be applied to the present invention for purposes of precision control, and consistent with the technologies flux vector control which offers the ability to achieve accuracy comparable to units with encoder feedback. Such control strategies rely on digital signal processor (DPS) type microcontrollers making 40,000 calculations per second or better to determine optimum power switching scenario's.

It is worth noting that the successful application of advanced job specific motor controls is in part indebted to the technological advancements in modeling and design strategies and their requisite tools such as CAD systems that utilized compatible soft ware such as Pro/Engineering and Solid edge for which incorporates Finite Element Analysis (FEA) and Nodal Analysis and all other applicable technologies that reduce design and manufacturing time, apply advanced fault detection, and supply sound control and diagnostic methods where the art and practice of motor controls are concerned, all of which offers quick unlimited possibilities to the idea of motor control strategies regardless of application and/or performance parameter scenario's.

Clearly great advancements have been realized in electric motor and motor controls in significant part due to improved magnetic materials, and the advent of powerful inexpensive computers. As a result electric motors have become integral components in vehicles, homes, and all aspects of offices and industries equipment.

The point being made is that the present invention does not oppose nor attempt to surpass the present state of art where electric motors and motor control technologies are concerned. Rather the present invention proposes embracing the present state of art of motors and motor control technologies as a means of taking electric motors to extreme new levels of performance and application.

With precision modifications and balancing of existing electric motor designs in conjunction with precision modification and programming of the requisite electronic control components—the present invention does what the present state of art has not yet done, and that is to turn electric motors into precision controlled dual rotational apparatuses and/or precision controlled frictionless clutch systems.

As a result the present invention offers extreme new solutions and extreme new levels of performance parameters and applications with reference to industry efforts that focus on addressing systems inefficiencies, and making systems more effective and versatile through greater precision control capabilities.

### BRIEF SUMMARY OF THE PRESENT INVENTION

Revolution Stabilization Control (RSC) System. Just as the title implies—the non-obvious and novel utility herein rests with the fact that the present invention offers a revolutionary new method of precision rotary speed control of accessory systems when retrofitted onto primary rotational drive systems that run at speeds and/or with fluctuation that are often greatly out of sync with the maximum efficiency speed requirements of said accessory systems.

Using vehicle application as an example—the harmonic balancer and/or accessory systems drive pulley supply the necessary power required to turn a subject vehicles accessory systems (i.e. water pump, alternator, AC pump, power steering pump, etc.) via drive belts. Said accessory systems are consequently dependant upon the RPM of the subject vehicles engine, for which most often turns at speeds far greater than is necessary to meet the optimum efficiency speeds of said accessory systems. This reality creates a very significant waste of energy and engine output power. In addition, most vehicles operate under conditions that cause routine fluctuations in engine RPM—a fact that further contributes to energy inefficiency, and unnecessary engine output power loss, all at a rata that can be calculated through the principles and formulas governing the laws of motion.

Through application of the present invention for which would replace the subject vehicles harmonic balancer and/or accessory system drive pulley with our RSC Systems precision modified and balanced electric motor, the present invention effectively offers a method of allowing the vehicles accessory systems to turn at a steady state maximum efficiency speed completely independent of the vehicles engine speed and fluctuations.

To exemplify the point of invention—conventional electric motor drives at work in a vast spectrum of task specific applications all adhere to the principle that the designated motors case/stator be affixed or mounted in a stationary position in relation to the machine of apparatus said motor is intended to supply working torque to, e.g. a power drill, washing machines, the electric windows in a vehicle, electric motor drives to power industrial conveyor belts, etc., etc. Consequently it is the designated electric motors rotor that transfers the working rotational torque through the coupling of said rotor to a specific mechanical apparatus.

In contrast, it is the present inventions case/stator that trasfers the working rotational torque, while the rotor of the present inventions motor is coupled to a primary rotational power source such as the crank output shaft of the vehicles engine in the above stated example. To further elaborate, when a vehicle accelerates beyond an idle, and/or travels at a rate of speed sufficient for city and county roads, or the open interstates, the RPM of it's engine most often far exceeds the optimum efficiency speed of the vehicles accessory systems. For example, if the subject vehicles water pump were to realize peak efficiency and performance at 1100 RPM when factoring in such things as water tension, and unit volume capacity—and the subject vehicles engine is turning at a rate of 2500-3000 RPM to maintain a traveling speed of 60 MPH—the net effect becomes a very significant waste of energy and subsequent engine output power to turn said water pump at 1400-1900 RPM beyond it's optimum efficiency and effectiveness speed.

The present invention offers a solution to the problem by allowing a vehicles accessory systems to turn at a steady state maximum efficiency RPM consistent with precision controlled steady state speed of our systems motor case/stator of which is linked to the accessory system via the appropriate drive belts, while our motors rotor is subject to the excessive and fluctuating RPM of the subject vehicles crank output shaft for which it is coupled to.

### BRIEF DESCRIPTION OF THE DRAWINGS

FIG. 1 is a perspective view of a electric motor embodying the present invention, with illustrative reference to a precision modified and balanced case/stator capable of maintaining a rotational speed independent of the rotational speed of it's rotor. FIG. 1 also depicts the incorporation of a drive pulley superimposed onto the motors case/stator for the purpose of transferring working rotational torque to accessory systems such as those referenced in the vehicle example used for purposes of this application as a method of personifying the principles of the present invention.

FIG. 2 is a perspective view of a precision modified rotor embodying the present invention, and snowing an illustrative reference to the coupling bore necessary for attaching the motor assembly to the crank output shaft of a engine in a vehicle reflecting the example used for purposes of this application as a method of personifying the principles of the present invention.

FIG. 3 is a perspective view of precision modified end caps of the present inventions motor case/stator, and depicts the necessary elements of coupling said motor to a vehicle used as an example for purposes of this application in order to personify the present invention. FIG. 3 depicts perspective bearing assemblies, a power supply scenario, and sensor feedback/command input communication scenario.

FIG. 4 is a perspective view of the present invention coupled to the crank output shaft of a engine in a vehicle—a depiction of the example of vehicle application for purposes of this application.

### DETAILED DESCRIPTION OF THE PRESENT INVENTION

Consistent with the clear provisions governing utility, process, improvement, novelty, and non-obviousness as related to patent protection—it is the assertion of this inventor that the present invention takes a series of innovative and non-obvious steps in order to create revolutionary new and useful levels of performance and application of electric motors and electronic motor control components.

Subsequently it is again the assertion of this inventor that with precision modifications and balancing of conventional AC or DC electric motors the present invention—with the application of precision modified and programmed motor control electronic components—turns conventional motors into dual rotational machines as a revolutionary method of providing precision RPM control capabilities in reference to accessory systems that often are dependent upon the speeds of a primary drive system for which runs at at speeds that are greatly out of sync with the maximum efficiency and effectiveness speeds of said accessory systems, to say nothing of the general advantages of applying precision control capabilities to accessory systems completely independent of the speeds produced by a primary drive source such as the crank output shaft of a engine in a vehicle.

To reiterate the fact that the present invention offers great diversity this inventor will nonetheless stay with the concept of retrofitting a vehicle for purposes of describing the present invention.

To reiterate the advantages and usefulness of vehicle application—when a vehicles engine accelerates beyond an idle to achieve the necessary rates of speed sufficient for said vehicle to travel city and county roads, or interstates, the RPM range of a vehicles engine far exceeds the optimum effectiveness and efficiency RPM range of the vehicles accessory systems.

For instance, factoring in such things as the effects of water tension and the volume capacity of a engines water pump—if said pumps peak performance and efficiency is realized at say 1200 RPM, and the subject vehicles engine is turning at a rate of 2500-3000 RPM to maintain a traveling speed of 60 MPH, the net effect becomes a very significant waste of energy and engine power to maintain the un-necessary work load place on the vehicles engine to turn it's water pump at 1300-1800 RPM beyond it's optimum effectiveness and efficiency RPM. To further expand the point—a vehicle most often operates under conditions that routinely require accelerate/decelerate. That reality creates a exponential waste of energy and power to routinely accelerate a vehicles accessory systems beyond their optimum efficiency range. Newtons second law of motion exemplifies that point by explaining the “the acceleration of an object is directly proportional to the resulting force acting upon it, and inversely proportional to the objects mass”. The effects of the foregoing fact is compounded by each of a subject vehicles accessory systems—i.e. power steering pumps, AC pumps, alternators, smog pumps, etc.

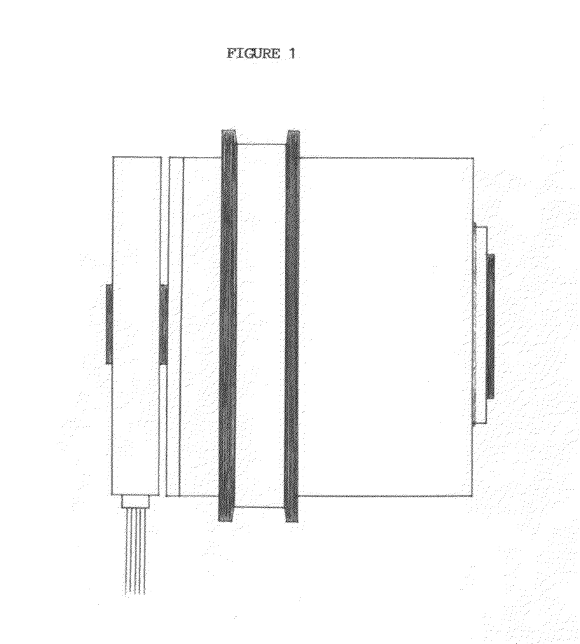

With reference to FIG. 1, the precision modified case/stator of the motor embodying the present invention is in fact symmetrical in shape, and stabilized to maintain steady state rotational speeds consistent with the designated maximum efficiency speeds of a subject vehicles accessory systems.

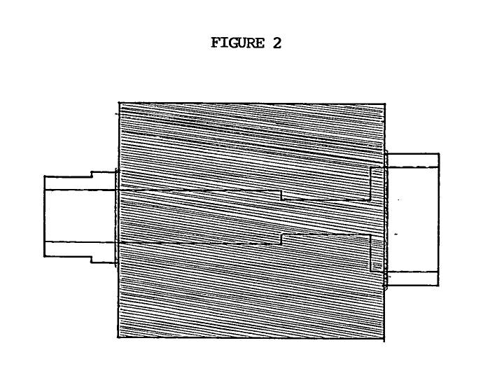

With reference to FIG. 2, the precision modified rotor assembly of the present inventions motor will have no output shafts, wherein a precision bore will be machined into said rotor for the purpose of coupling the subject matter RSC Systems motor to a subject vehicles engine crank output shaft in place of said vehicles harmonic balancer and/or accessory systems drive pulley.

The rotor assembly of our systems motor will receive a counter bore for the purpose of receiving a set bolt to hold our systems motor in place—a approach comparable to which holds a conventional harmonic balancer and/or accessory system drive pulley in place.

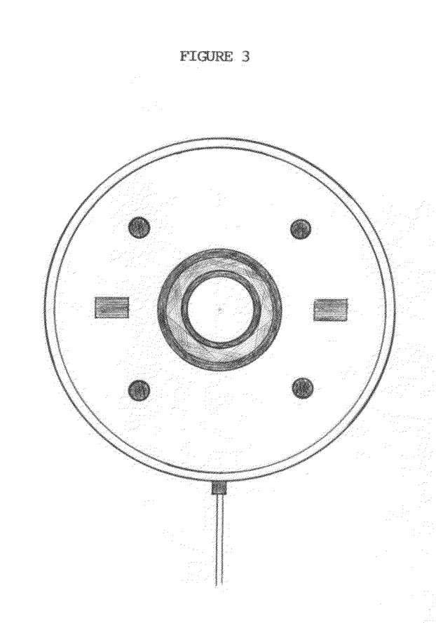

With reference to FIG. 3, an overview is shown of the end caps of the subject matter RSC System's motor assembly. Said end caps are modified to effectively accommodate the necessary bearing assemblies, and the coupling scenario of our systems motor to a subject vehicles engine crank output shaft. FIG. 3 also depicts a perspective power supply scenario, sensor monitoring and feedback reference, and a MCU command input and communication reference.

It is relevant to note that with the technological advancements for which exist today, a number of wireless power supply options may exist to effectively accommodate the needs of the present invention, however for the sake of simplicity, and for the sake of this application—power supply is being applied with reference to the tried and proven method of carbon/graphite brushes, noting that as a matter of fact, if properly set brushes can realize thousands of hours of use—and replacement brushes are generally inexpensive, and considered a simple maintenance endeavor.

Clearly the innovative and useful principles of the present invention rest with the fact that with precision modifications, our RSC Systems electric motor drive component can be made to function as a dual rotational machine, wherein the rotor of our modified motor will be dependent upon the RPM of the engine crank output shaft it is coupled to, while the requisite case/stator speed will be independently set through electronic control components synonymous with the maximum efficiency rotational speed of a subject vehicles accessory systems.

Consistent with the foregoing explanations, and noting that with proper modifications the electric motor (dual rotational apparatus), and electronic control component for which will comprise the embodiment of the present invention will be as self contained as possible—installation of our RSC System will become a simple process of removing a subject vehicles harmonic balancer and/or accessory systems drive pulley, and replacing than with the precision modified and balanced motor drive unit of the present invention.

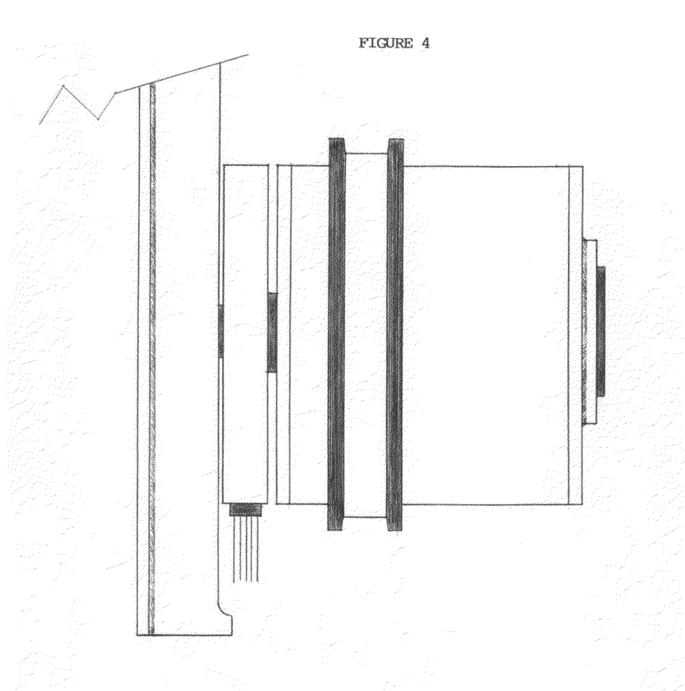

The precision bore in our motor units rotor will allow the unit to slid over the subject vehicles crank output shaft, and be bolted in place with a bolt matching the thread bore cut into said crank output shaft (refer to FIG. 2, and FIG. 4). With our modified motor unit securely bolted into it's necessary place as a replacement of the subject vehicles harmonic balancer and/or accessory systems drive pulley—the accessory systems belt, or belts depending on vehicle make/modal will be secured in place around the requisite drive belt pulley superimposed around the precision modified case/stator of our motor unit.

The power supply link, and MCU/sensor communications links would be connected to the stationary portion of our motor units and cap (refer to FIG. 3) by hard wire running from requisite control components securely mounted in the most appropriate and un-intrusive place of a subject vehicle depending upon the design specifications of make/model.

The stationary portion of said end cap could potentially be secured with a simple metal tab, and set bolt that utilizes the threaded set bore in the timing covers of most vehicles for the purpose of securing the gauge used for measuring engine timing. Note that the foregoing is but the most obvious of many potential options of effectively securing the stationary portion of our motor units end cap for which is to serve as a power supply link, and control communications link.

It is the sincere belief of this inventor that those of ordinary skill in the relevant arts will have no problem determining that numerous potential modification options, and component substitution scenario's exist with reference to the embodiments of the subject matter invention without departing from the principles and scope of invention. Accordingly, the foregoing summarization of this specification is to be taken in an illustrative sense, and not a definitive or limiting sense. It is the assertion of this inventor that while the principles of invention remain constant—component substitutions, and/or modifications relevant to the principles of invention can be as diverse and broad as performance and application parameters of the present invention.

What is claimed is:

1. The primary claim of invention is that through novel and non-obvious flash of ingenious the subject matter RSC System presented herein proposes a revolutionary method of converting conventional electric motors, and electronic motor control components into precision controlled dual rotational machines for the purpose of providing revolutionary new control capabilities for accessory systems thus offering extreme new effectiveness and efficiency parameters to the equation.

2. The asserted principles of invention as defined in claim 1 are unambiguous and should be self supporting to those versed and experienced in the art and practice of electric motor, and motor control design and manufacture. And while the asserted principles of invention will remain constant, the method of application and use of the principles of invention hold extreme potential for diversity—diversity limited only by the imagination of electric motor, and motor control designers and engineers working in conjunction with consumer demands.

3. The embodiment of the present invention as defined in claims 1 and 2 will consist of a electric motor that regardless of make model or size will in fact require:
a) A precision modified and balanced case/stator capable of producing and maintaining a steady state rotational speed independent of the rotational speeds of the units rotor, and consistent with the power supply needs of the accessory system, or systems the subject matter RSC System is to provide working drive torque to.
b) That a method of transferring the working rotational torque of the present inventions case/stator be superimposed onto said case/stator, (refer again to the drive pulley example for vehicle application as referenced at [0022] and FIG. 1.)
c) Some form of effective modifications to it's rotor for the purpose of coupling the subject matter RSC Systems motor drive unit to a primary rotational drive source, (refer again to [0023] and FIG. 2)
d) Effective and efficient electronic control components designed and modified to accommodate the task specific command requirements of application of the present invention. Command requirements that will vary dependent upon task specific application.
